(19) United States
(12) Patent Application Publication
(10) Pub. No.: US 2016/0322932 A1
(43) Pub. Date: Nov. 3, 2016

(54) HYBRID SOLAR THERMAL SYSTEM

(71) Applicant: Dong II LEE, Daejeon (KR)

(72) Inventor: Dong II LEE, Daejeon (KR)

(21) Appl. No.: 14/979,995

(22) Filed: Dec. 28, 2015

(30) Foreign Application Priority Data
Apr. 28, 2015 (KR) 10-2015-0059965

(51) Int. Cl. H02S 40/44

(52) U.S. Cl. CPC H02S 40/44

(57) ABSTRACT

Disclosed is a hybrid solar thermal system, including: a solar cell panel configured to absorb solar heat to generate electricity, and transmit the generated electricity in connection with a system of a power supply company; a thermal storage tank configured to heat inside fluid by using the electricity drawn from the power supply company to provide air conditioning; a boiler configured to provide the fluid heated by the thermal storage tank to provide heating; and a cooling device configured to allow the fluid heated by the thermal storage tank to flow in a heating unit and provide cooling through heat exchange, in which the solar cell panel includes: a plurality of solar cells configured to absorb solar light and generate electricity; partitions which are installed at lower ends of the plurality of solar cells, and allow a fluid that is any one of air or water to be circulated; an insulating material configured to block heat loss to the air; and a finishing material configured to surround the solar cell.

### CROSS-REFERENCE TO RELATED APPLICATION

This application claims priority to and the benefit of Korean Patent Application No. 10-2015-0059965 filed in the Korean Intellectual Property Office on Apr. 28, 2015, the entire contents of which are incorporated herein by reference.

### BACKGROUND OF THE INVENTION

(a) Field of the Invention

The present invention relates to a hybrid solar thermal system.

(b) Description of the Related Art

Power generation using solar energy includes photovoltaic power generation, which converts solar light into electric energy, solar thermal power generation, which converts solar heat into electric energy, solar heat collecting power generation, which collects solar heat and then uses the collected solar heat for heating or hot water, and the like. The power generation methods using solar energy still have low use efficiency, thereby having low economic efficiency. Accordingly, the development of various methods using solar energy has been required.

An example of a hybrid device using solar energy includes a device using photovoltaic power generation and a solar thermal system. However, since the photovoltaic power generation and the solar thermal system are separated from each other, in order to simultaneously use electricity and heating heat, there is a disadvantage in that the two facilities, which are spatially separated, need to be used together.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a hybrid photovoltaic power generation and solar thermal system, which may improve efficiency of a solar cell, and utilize heat generated by the solar cell in a solar thermal system.

An exemplary embodiment of the present invention provides a hybrid solar thermal system, including: a solar cell panel configured to absorb solar heat to generate electricity, and transmit the generated electricity in connection with a system of a power supply company; a thermal storage tank configured to heat an inside fluid by using the electricity drawn from the power supply company to provide heating or cooling; a boiler configured to provide the fluid heated by the thermal storage tank to provide heating; and a cooling device configured to allow the fluid heated by the thermal storage tank to flow in a heating unit and provide cooling through heat exchange, in which the solar cell panel includes: a plurality of solar cells configured to absorb solar light and generate electricity; partitions which are installed at lower ends of the plurality of solar cells, and allow a fluid that is any one of air and water to be circulated; an insulating material configured to block heat loss to the air; and a finishing material configured to surround the solar cell.

According to the present invention, it is possible to implement various forms of solar thermal system, so that it is possible to efficiently use the various forms of solar thermal system in various fields.

### BRIEF DESCRIPTION OF THE DRAWINGS

FIGS. 1A and 1B are diagrams of an example of a solar thermal system according to an exemplary embodiment of the present invention.

FIG. 2 is a diagram of an example of a solar cell panel according to a first exemplary embodiment of the present invention.

FIG. 3 is a diagram of an example of a solar cell panel according to a second exemplary embodiment of the present invention.

FIG. 4 is a diagram of an example of a solar cell panel according to a third exemplary embodiment of the present invention.

FIG. 5 is a diagram of an example of a solar cell panel according to a fourth exemplary embodiment of the present invention.

FIG. 6 is a diagram of an example of a solar cell panel according to a fifth exemplary embodiment of the present invention.

FIG. 7 is a diagram of an example of a solar cell panel according to a sixth exemplary embodiment of the present invention.

FIG. 8 is a diagram of an example, in which a solar cell panel according to an exemplary embodiment of the present invention is installed.

FIG. 9 is a diagram of an example of a structure installed on a rear surface of the solar cell panel according to the first exemplary embodiment of the present invention.

FIG. 10 is a diagram of an example of a connection pipe connection socket according to an exemplary embodiment of the present invention.

FIG. 11 is a diagram of an example of a structure installed on a rear surface of the solar cell panel according to the second exemplary embodiment of the present invention.

FIG. 12 is a diagram of an example of the rear surface of the solar cell panel according to the first exemplary embodiment of the present invention.

FIG. 13 is a diagram of an example of the rear surface of the solar cell panel according to the second exemplary embodiment of the present invention.

FIGS. 14A and 14B are diagrams of an example of the rear surface of the solar cell panel according to the third exemplary embodiment of the present invention.

FIGS. 15A to 15C are diagrams of an example of a method of installing the solar cell panel according to the first exemplary embodiment of the present invention.

FIG. 16 is a diagram of an example of a method of installing the solar cell panel according to the second exemplary embodiment of the present invention.

FIG. 17 is a diagram of an example, in which a plurality of solar thermal systems according to the first exemplary embodiment of the present invention is installed.

FIG. 18 is a diagram of an example, in which a plurality of solar thermal systems according to the second exemplary embodiment of the present invention is installed.

FIGS. 19A and 19B are diagrams of an example, in which a solar thermal system according to an exemplary embodiment of the present invention is installed in an actual living environment.

FIGS. 20A and 20B are diagrams of an example of the application of the solar cell according to the first exemplary embodiment of the present invention.

FIGS. 21A and 21B are diagrams of an example of the application of the solar cell according to the second exemplary embodiment of the present invention.

FIG. 22 is a structure diagram of a cooling device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

Hereinafter, a hybrid photovoltaic power generation and solar thermal system according to an exemplary embodiment of the present invention will be described with reference to the drawings.

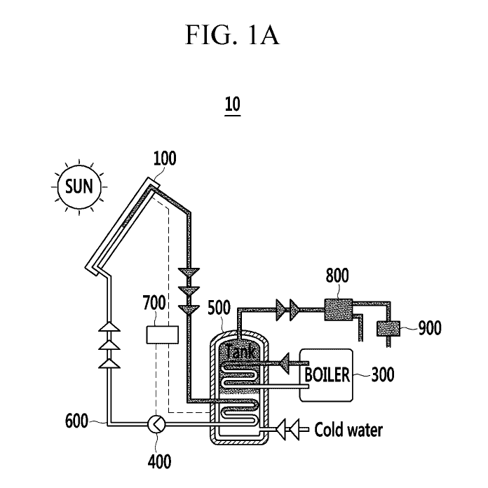

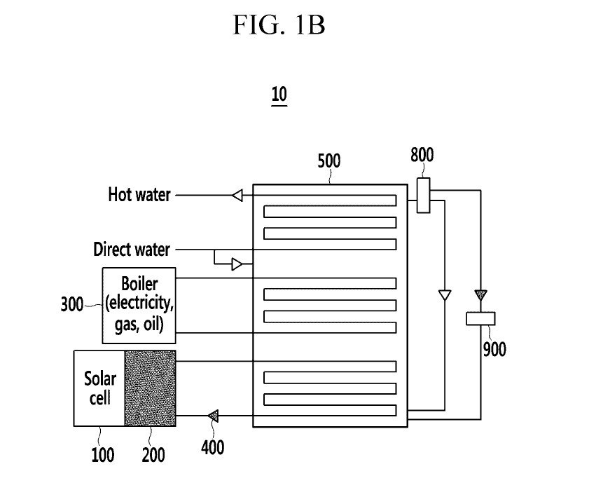

FIGS. 1A and 1B are diagrams of an example of a solar thermal system according to an exemplary embodiment of the present invention.

FIG. 1A is a diagram of an example of hybrid photovoltaic power generation using a solar thermal system 10, and FIG. 1B schematically illustrates the diagram of the example illustrated in FIG. 1A.

As illustrated in FIGS. 1A and 1B, when the sun is up, electricity generated by a solar cell panel 100 is system-connected with a power supply company (for example, the Korean Electric Power Corporation), which supplies power, and is transmitted to the power supply company. Further, at night requiring heating, the solar cell panel 100 draws midnight electricity from the power supply company by using a boiler 300 to heat a fluid stored within a thermal storage tank 500. In the exemplary embodiment of the present invention, for convenience of the description, one including the solar cell panel 100, the thermal storage tank 500, the boiler 300, and a cooling device 900 is called the solar thermal system 10, but the present is not essentially limited thereto.

When a temperature of a solar thermal absorbing device 200 installed at a back sheet of the solar cell in the daytime is different from a temperature of the thermal storage tank 500 by a predetermined temperature or more, the pump 400 is automatically circulated. Accordingly, heat is exchanged in the thermal storage tank 500 and the temperature of the thermal storage tank 500 is increased. Here, the pump 400 may use heat absorbed by the solar thermal absorbing device 200, which is installed on the back sheet of the solar cell, as a heat source.

A fluid circulating through a cooling pipe 600 of the solar thermal absorbing device 200 may be prevented from freezing and bursting in the winder by inserting an antifreeze, such as propylene glycol. Heat water or heating may be obtained by directly connecting a water supply utility to the thermal storage tank 500 as illustrated in FIG. 1, or a hot water pipe and a heating pipe may be separately provided by additionally installing a heat exchanger within the thermal storage tank 500.

Further, a setting temperature, and the like of the thermal storage tank 500 may be remotely controlled through a control unit 700 of the solar thermal system 10 by using a mobile terminal (not illustrated). Further, it is possible to control an operation time of the boiler 300 by setting a timer. The remote control method by using the mobile terminal or the method of controlling the operation time of the boiler 300 may be performed by various methods, so that the exemplary embodiment of the present invention is not described with the limitation to any one method.

A selection switch 800 provides the heated fluid to a heating pump or makes the heated fluid flow into a cooling pump according to a selection of heating or cooling input from the outside.

The thermal storage tank 500 exchanges heat by providing the heated fluid to a heating unit of the cooling device 900, so that cooling may be provided together. A structure of the cooling device 900 will be described in detail below.

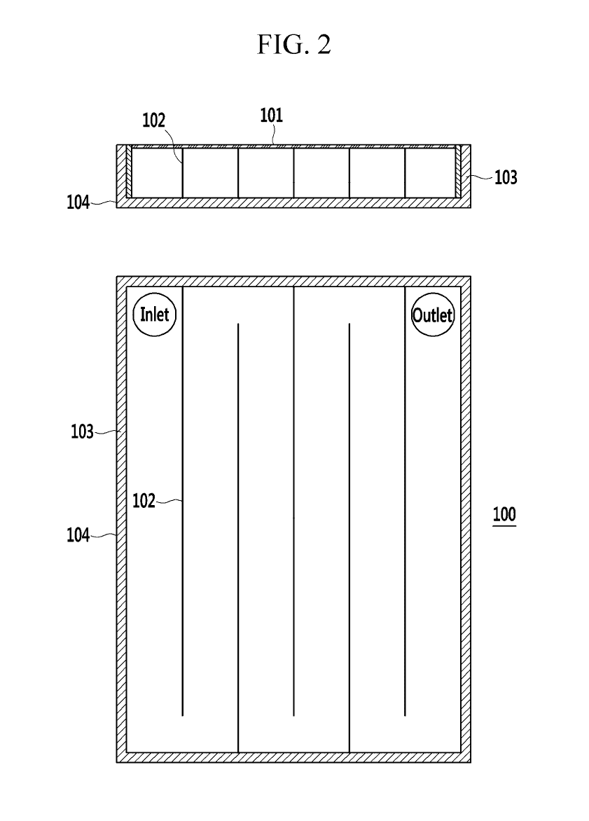

A method of configuring the solar cell panel 100 for providing heating or cooling by the solar thermal system 10 will be described with reference to FIGS. 2 to 7.

FIG. 2 is a diagram of an example of a solar cell panel according to a first exemplary embodiment of the present invention.

As illustrated in FIG. 2, the solar cell panel 100 includes a solar cell 101, which absorbs solar light and produces electricity, and partitions 102, which is installed at a lower end of the solar cell 101 and makes air flowing into the solar cell panel 100 be circulated. Further, an inlet and an outlet of air are provided on the back sheet of the solar cell 101, so that the air may absorb heat from the solar cell 101 well while passing through. The first exemplary embodiment of the present invention is described based on an example, in which the outlet of air is provided at, for example, the lower end of the solar cell 101.

The exemplary embodiment of the present invention is described based on an example, in which the partitions 102 are installed in a zigzag type. Further, the exemplary embodiment of the present invention is described based on an example, in which a material of the partition 102 may be, for example, copper, aluminum, stainless or plastic.

An insulating material 103 is installed at upper, lower, left, and right sides of the solar cell 101 in the form surrounding the solar cell 101, thereby preventing heat loss to the air. Further, the exemplary embodiment of the present invention is described based on an example, in which the solar cell 101 is finishing-processed with a finishing material 104, such as aluminum, stainless or plastic, which surrounds the insulating material 103 of the solar cell 100.

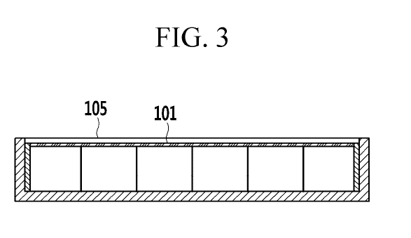

FIG. 3 is a diagram of an example of a solar cell panel according to a second exemplary embodiment of the present invention.

As illustrated in FIG. 3, a solar cell 101 according to a second exemplary embodiment of the present invention is described based on an example, in which the solar cell 101 according to the second exemplary embodiment basically has the same configuration as that of described with reference to FIG. 2. However, a heat loss blocking material 105 is additionally installed at the upper end of the solar cell panel 100 according to the first exemplary embodiment of FIG. 2, that is, an upper end of the solar cell 101, so that the heat loss blocking material 105 may additionally block heat loss to the air together with the insulating material 103.

The exemplary embodiment of the present invention is described based on an example, in which low iron tempered glass is used as the heat loss blocking material 105. Further, the exemplary embodiment of the present invention is described based on an example, in which a thickness of the heat loss blocking material 105 is 5 mm, but is not essentially limited thereto.

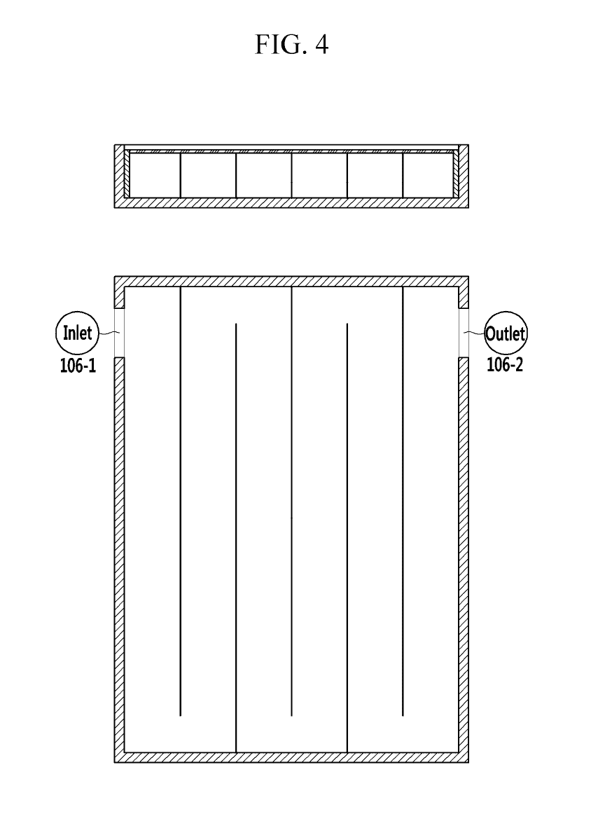

FIG. 4 is a diagram of an example of a solar cell panel according to a third exemplary embodiment of the present invention.

As illustrated in FIG. 4, unlike the implementation in which the outlet of air is provided at the lower end of the solar cell 101 in the first and second exemplary embodiments, outlets 106-1 and 106-2 of air are formed at left and right sides of the solar cell panel 100 in the third exemplary embodiment of the present invention. The exemplary embodiment of the present invention is illustrated based on an example, in which the outlets 106-1 and 106-2 of the solar cell panel are positioned at an upper end of the solar cell panel, but the outlets 106-1 and 106-2 may also be positioned at a lower end or the upper end and the lower end of the solar cell panel.

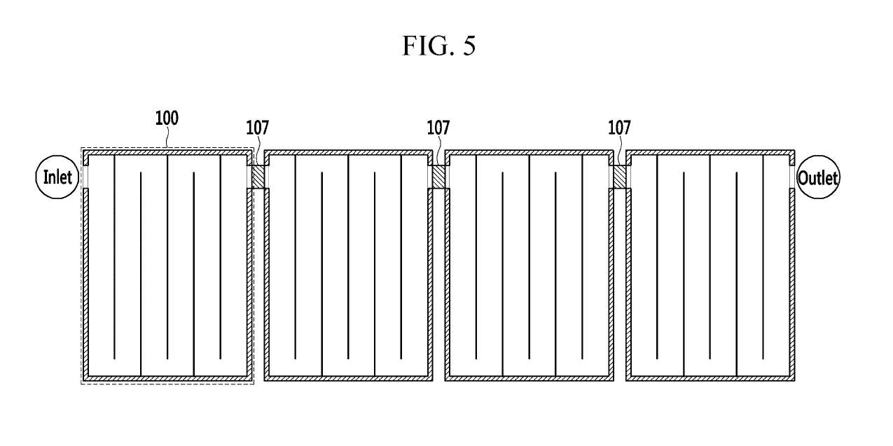

FIG. 5 is a diagram of an example of a solar cell panel according to a fourth exemplary embodiment of the present invention.

As illustrated in FIG. 5, the fourth exemplary embodiment of the present invention is described based on an example, in which a plurality of solar cell panels 100 is connected. Further, in order to connect the plurality of solar cell panels 100 to each other, connection pipes 107 are installed between the plurality of solar cell panels 100. The connection pipe 107 may be implemented with various kinds of material, but the exemplary embodiment of the present invention is not limited to any one material.

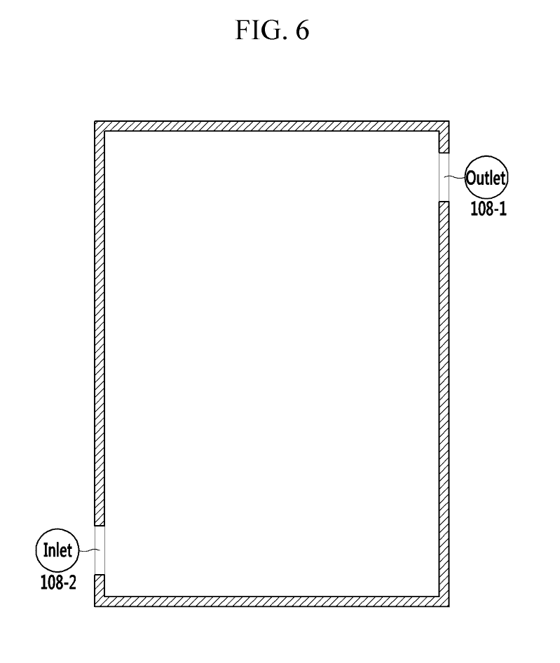

FIG. 6 is a diagram of an example of a solar cell panel according to a fifth exemplary embodiment of the present invention.

The solar cell panel 100 according to the fifth exemplary embodiment of the present invention is installed while a position of an inlet/outlet of air is changed. That is, as illustrated in FIG. 6, an outlet 108-1 of air is installed to be provided at an upper end of the solar cell panel 100, and an inlet 108-2 of air is installed to be provided at a lower end of the solar cell panel 100.

The fifth exemplary embodiment of the present invention is described based on an example, in which the outlet of air is installed to be provided at the upper end of the solar cell panel and the inlet of air is installed to be provided at the lower end of the solar cell panel, but the positions of the outlet and the inlet of air may also be changed to be contrary to the position mentioned in FIG. 6. Further, FIG. 6 illustrates the form, in which a partition is not provided at a rear side of the solar cell panel, but the present invention is not essentially limited thereto.

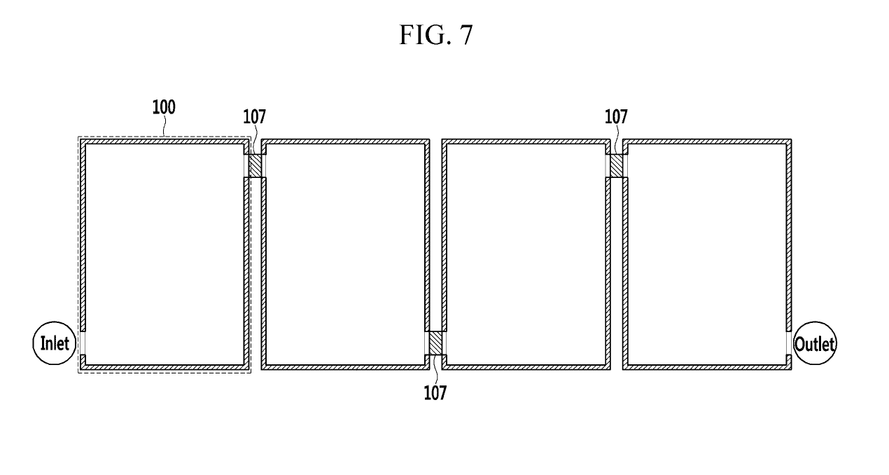

FIG. 7 is a diagram of an example of a solar cell panel according to a sixth exemplary embodiment of the present invention.

As illustrated in FIG. 7, the solar cell panel 100 according to the sixth exemplary embodiment of the present invention is implemented by connecting the plurality of solar cell panels according to the fifth exemplary embodiment of FIG. 6. Further, in order to connect the respective solar cell panels 100, connection pipes 107 installed between the solar cell panels may also be implemented to be positioned at various positions, such as an upper and a lower end of the solar cell panel 100, unlike FIG. 5. As described above, various solar cell panels may be implemented according to the position of the connection pipe 107 installed between the solar cell panels or the positions of the outlet and the inlet of air, through which air may be in and out, and the solar cell panel may also be implemented in various forms, which are not mentioned in the exemplary embodiment of the present invention.

The solar cell panels according to the first to sixth exemplary embodiments have been described based on the example, in which air passes through the inlet and the outlet so as to absorb heat well, but the solar cell panel may also use water, instead of air, so as to absorb heat well, but the solar cell panel may also use water, instead of air, so as to absorb heat well.

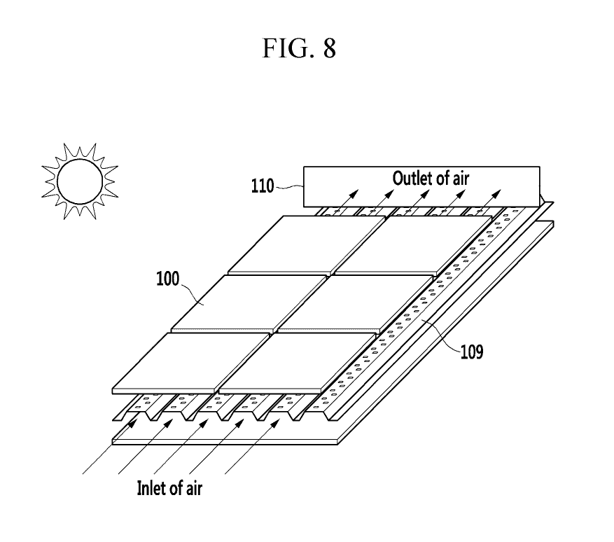

Next, an example, in which the solar cell panel 100 described with reference to FIGS. 2 to 7 is actually installed, will be described with reference to FIG. 8.

FIG. 8 is a diagram of an example, in which a solar cell panel according to an exemplary embodiment of the present invention is installed.

As illustrated in FIG. 8, the solar cell panel 100 is laid on an installation board 109, and an inlet port of air is implemented so that air may pass through a space formed at a lower end of the solar cell panel 100. Further, an air tank 110 implemented at an upper end of the installation board 109 collects air absorbed through the inlet port and then makes air be discharged to the outside through an outlet of air, so that the air may be used for heating or cooling.

In FIG. 8, the inlet ports of air are installed to be parallel, but may be serially installed according to a case. The serially installed inlet ports of air may be installed in various shapes, so that the exemplary embodiment of the present invention is not described with the limitation to any one form.

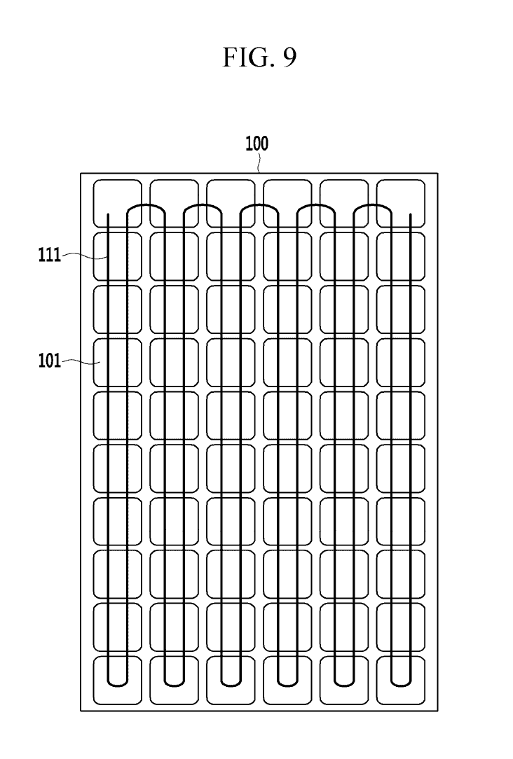

Next, a structure installed on a rear surface of the solar cell panel 100 will be described with reference to FIGS. 9 to 11.

FIG. 9 is a diagram of an example of a structure installed on the rear surface of the solar cell panel according to the first exemplary embodiment of the present invention.

As illustrated in FIG. 9, the plurality of solar cells 101 forming the solar cell panel 100 is connected by connection pipes 111. The exemplary embodiment of the present invention is described based on an example, in which as the connection pipe 111 installed on the rear surface of the solar cell panel 100 and connecting the plurality of solar cells 101, a silicon hose, an ethylene vinyl acetate (EVA) hose, a urethane hose, a copper pipe, an aluminum pipe, a stainless pipe, or plastic pipe is vertically connected in serial-parallel.

Further, the exemplary embodiment of the present invention is described based on an example, in which the connection pipe 111 is attached to the solar cell panel 101 by a thermal conductive adhesive, a tape, silicon, or the like. Here, the exemplary embodiment of the present invention is described based on an example, in which as the thermal conductive adhesive, an adhesive containing a component of silicone modified polymer (20˜30%), fillers (60˜70%), silica (1˜5%), paraffin (1˜5%), carbon black (<0.1), organic tin compound (0.1˜5%) is used.

The exemplary embodiment of the present invention is described based on an example, in which the connection pipe 111 is surrounded by an insulating material (for example, polyester, glass, wool, glass fiber, Isopink or Styrofoam, Neopor), and is finishing-processed by a plastic material, such as aluminum, stainless or plastic. Here, a groove may be formed in the insulating material such that the connection pipe 111 can be easily inserted therein, and the insulating material where the connection pipe 111 is inserted is fixed to the bottom surface of the solar cell panel 101 using an adhesive.

Further, it is possible to prevent heat loss to the outside by using low iron tempered glass on an upper surface, which is opposite to the position of the solar cell panel 100 illustrated in FIG. 9. The structures installed on the back sheet of the solar cell are implemented in the form of a module, thereby being easily attached onto the rear surface of the solar cell panel 100.

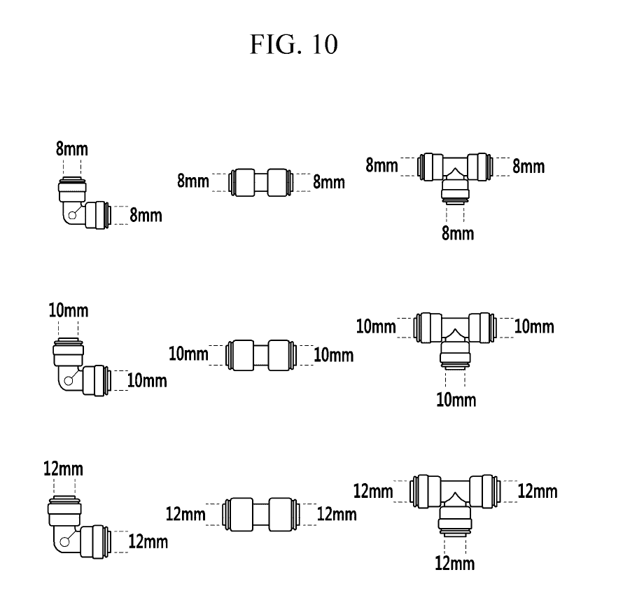

Here, in order to connect the connection pipes 111 to be long so that all of the solar cells 101 are connected, in the exemplary embodiment of the present invention, various forms of socket are used, and the form of the socket will be described with reference to FIG. 10.

FIG. 10 is a diagram of an example of a connection pipe connection socket according to an exemplary embodiment of the present invention.

As illustrated in FIG. 10, the connection pipe 111, such as a plastic pipe or a urethane hose, may be connected onto the rear surface of the solar cell panel 100 in serial-parallel by using a socket. The exemplary embodiment of the present invention is described based on an example, in which, as illustrated in FIG. 10, the connection pipes are connected in serial-parallel by using various sockets, and the connection pipe 111 extended through the serial-parallel connection is attached to the solar cell panel 100 and used, so that the plurality of solar cells 101 is connected.

In the exemplary embodiment of the present invention, it is illustrated as an example that the socket shaped like “ [symbol] ”, “ [symbol] ”, or “ [symbol] ” is used, and has a diameter of 8 mm, 10 mm, or 12 mm, but the socket is not essentially limited thereto.

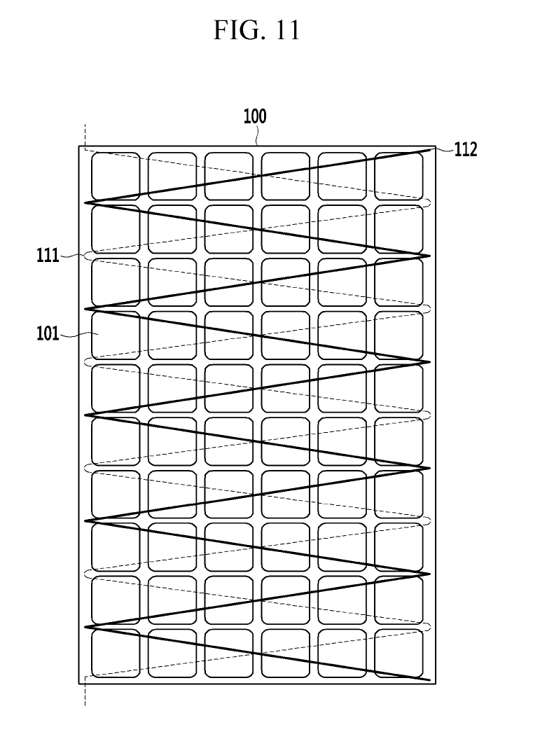

In the meantime, FIG. 11 is a diagram of an example of a structure installed on the rear surface of the solar cell panel according to the second exemplary embodiment of the present invention.

As illustrated in FIG. 11, when the connection pipe 111 is attached to the rear surface of the solar cell panel 100 by any one of a thermal conductive adhesive, a tape, and silicon in a state where the connection pipe 111 is connected to be long in serial-parallel by using the socket, one end of the connection pipe 111 is fixed to the solar cell panel 100 by using a fixing device 112.

In this case, the exemplary embodiment of the present invention is described based on an example, in which a wire is used as the fixing device 112, but the fixing device 112 is not essentially limited thereto. Further, the exemplary embodiment of the present invention is described based on an example, in which the form, in which the connection pipe 111 is attached to the rear surface of the solar cell panel 100, is not connected in a vertical structure as mentioned with reference to FIG. 9, but is implemented in a zigzag form which is the similar form to that of the fixing device 112, but is not essentially limited thereto.

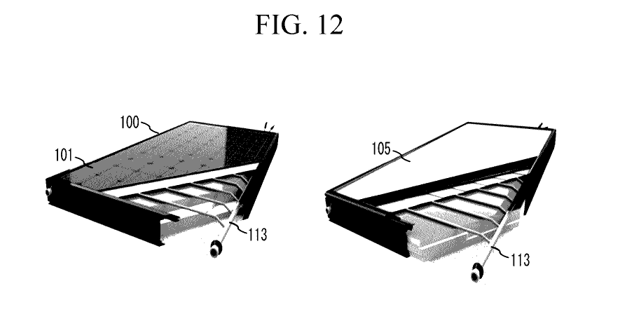

Next, the form of the rear surface of the solar cell panel 100 implemented in various forms will be described with reference to FIGS. 12 to 14.

FIG. 12 is a diagram of an example of the rear surface of the solar cell panel according to the first exemplary embodiment of the present invention.

As illustrated in FIG. 12, a copper pipe 113 is installed in parallel on the rear surface of the solar cell panel 100, so that heat generated by the solar cell 101 moves to a fluid inside the copper pipe 113, and thus the copper pipe 113 serves to transfer heat. In the exemplary embodiment of the present invention, the fluid is not limited to any one type, and the method of transferring, by the fluid, heat inside the copper pipe 113 is an already well-known matter, so that a detailed description of the method is omitted in the exemplary embodiment of the present invention.

Here, the exemplary embodiment of the present invention is described based on an example, in which an EVA and PVF (back sheet) film is used on the back sheet of the solar cell 101, but the EVA and PVF film may be replaced with a heat absorbing plate (for example, copper or aluminum). In this case, when the heat absorbing plate is used, the heat absorbing plate may be used through plating-processing by anodizing or chromate.

Further, the solar cell 101 and the heat absorbing plate may be simultaneously used, and in this case, the solar cell 101 is attached onto the heat absorbing plate by using any one of a thermal conductive adhesive, a thermal conductive double-sided tape (thermal tape), and silicon for use. Further, any one of a silicon hose, an EVA hose, a urethane hose, a copper pipe, an aluminum pipe, a SUS pipe, and plastic pipe may be vertically connected in serial on a rear surface of the heat absorbing plate, and may be attached to the heat absorbing plate by using a thermal conductive adhesive, a tape, silicon, and the like.

Further, the copper pipe 113 or an aluminum pipe may be used, and in this case, the heat absorbing plate and the copper pipe or the heat absorbing plate and the aluminum pipe are ultrasonic welded for use. The pipe is surrounded with polyester, glass wool, glass fiber, and the like, which are insulating materials, and is finishing-processed with a material, such as aluminum, stainless or plastic. Further, it is possible to block heat loss to the outside by using an insulating material 105, such as low iron tempered glass, on the solar cell 100.

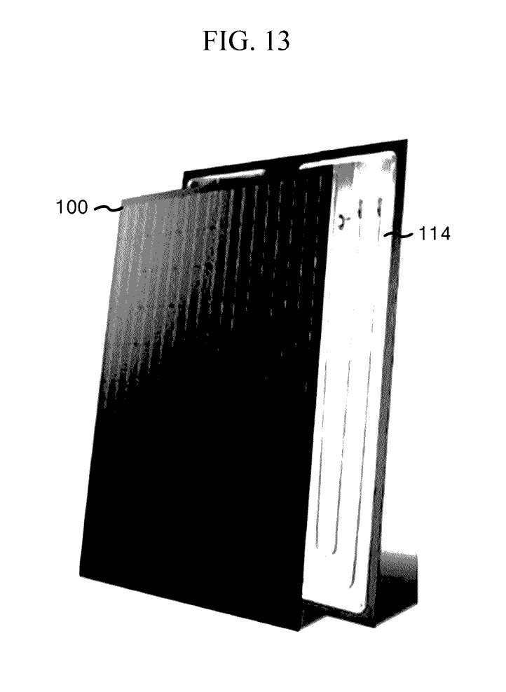

Here, an example of the back sheet of the solar cell, in which the heat absorbing plate casted by aluminum, which is plating-processed by anodizing or chromate, is installed on the back sheet of the solar cell 100 will be described with reference to FIG. 13.

FIG. 13 is a diagram of an example of the rear surface of the solar cell panel according to the second exemplary embodiment of the present invention.

As illustrated in FIG. 13, a heat absorbing plate 114, which is casted with aluminum, which is plating-processed by anodizing or chromate, is installed on the rear surface of the solar cell panel 100. In this case, the heat absorbing plate 114, which enables the solar cell panel 100 to absorb solar heat, is attached to the back sheet of the solar cell 100 by using any one of a thermal conductive adhesive, a tape, and silicon.

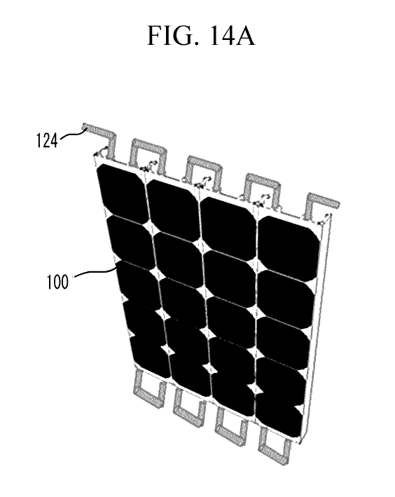

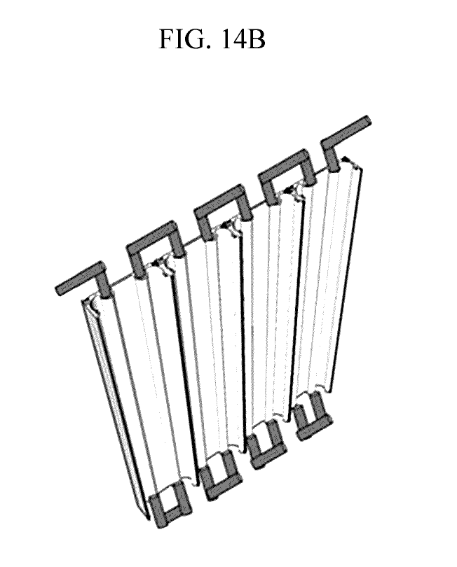

Another example of the rear surface of the solar cell panel 100 will be described with reference to FIG. 14.

FIGS. 14A and 14B are diagrams of an example of the rear surface of the solar cell panel according to the third exemplary embodiment of the present invention.

FIG. 14A illustrates a front surface of the solar cell 100, and FIG. 14B illustrates a back sheet of the solar cell 100.

As illustrated in FIG. 14, the solar cell 100 is attached onto the aluminum casted heat absorbing plate, which is plated by anodizing or chromate, by using any one of a thermal conductive adhesive, a thermal conductive dual-sided tape, or silicon. Pipes at the upper end and the lower end of the heat absorbing plate may be connected through a pipe 124 in serial or in parallel by using a socket.

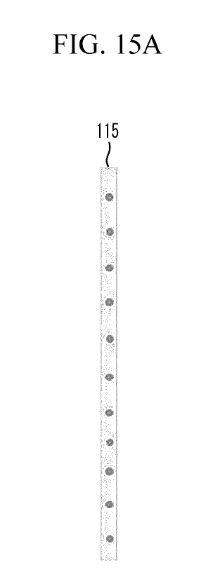

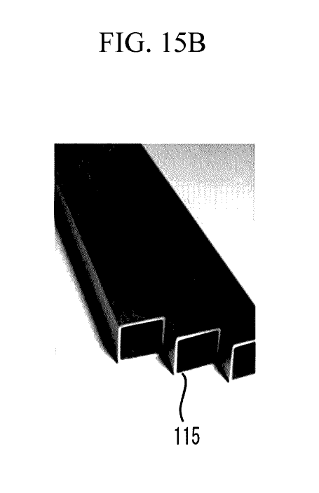

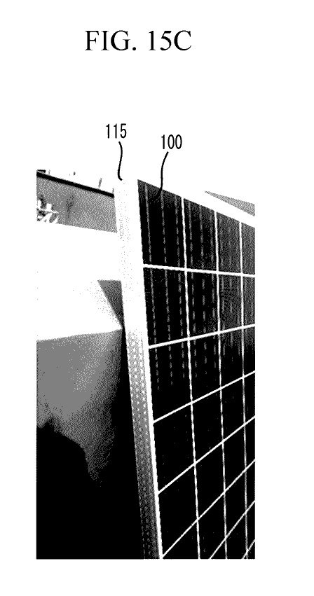

Next, a method of installing the solar cell panel 100 configured by the aforementioned various methods on a wall of a building will be described with reference to FIG. 15.

FIGS. 15A to 15C are diagrams of an example of a method of installing the solar cell panel according to the first exemplary embodiment of the present invention.

FIG. 15A is a front view of an aluminum quadrangular frame, and FIG. 15B is a top plan view of the aluminum quadrangular frame. Further, FIG. 15C is a side view of the solar cell 100, in which the aluminum quadrangular frame is installed.

As illustrated in FIG. 15, an aluminum quadrangular pipe 115 is vertically fixed onto a wall of a building, and tabs are made on a side surface of the aluminum quadrangular pipe 115. Further, a tab is also made on the aluminum on the side surface of the solar cell panel 100, and the aluminum quadrangular pipe 115 and the solar cell panel 100 are fastened to each other through the tabs formed on the side surfaces, respectively, by using screws. Two vertically installed aluminum quadrangular pipes 115 are connected by horizontally connecting the aluminum quadrangular pipes 115 by a method, such as electric welding, as necessary.

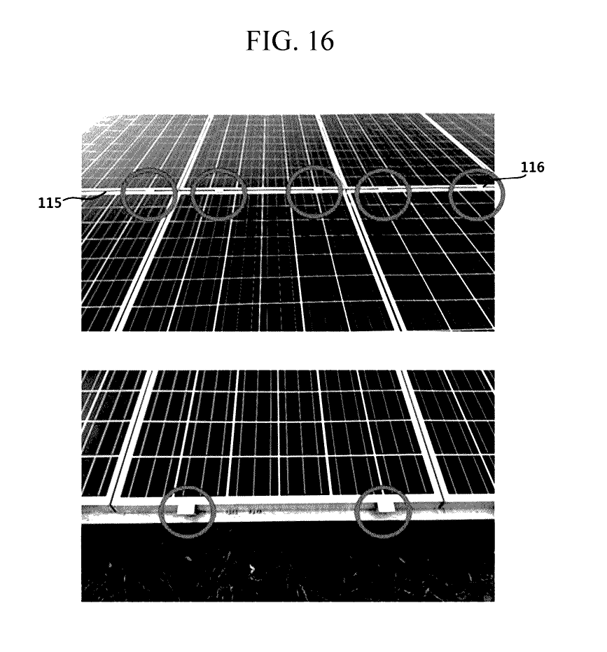

FIG. 16 is a diagram of an example of a method of installing the solar cell panel according to the second exemplary embodiment of the present invention.

As illustrated in FIG. 16, an aluminum quadrangular pipe 115 is horizontally installed, and the solar cell panel 100 is fixed by using a bolt and a nut 116.

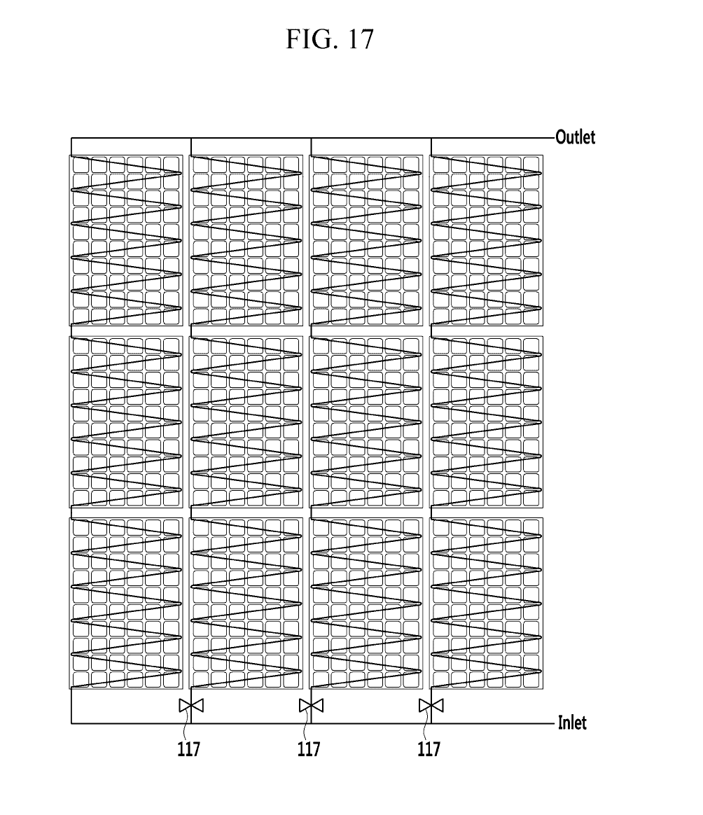

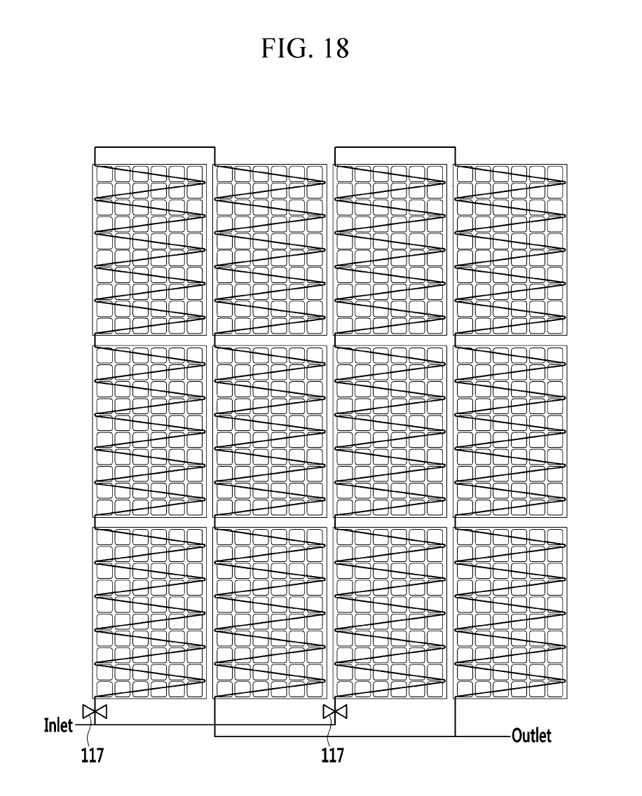

Next, a form, in which the plurality of solar cell panels 100 is provided and installed in an actual environment, will be described with reference to FIGS. 17 and 18.

FIG. 17 is a diagram of an example, in which a plurality of solar cell panels according to the first exemplary embodiment of the present invention is installed.

As illustrated in FIG. 17, when the plurality of solar cell panels 100 is connected and used, the plurality of solar cell panels 100 is installed so that the inlets thereof are positioned at lower ends thereof and outlets are positioned at upper ends thereof. Further, a plurality of valves 117 is installed at the inlet of the solar cell panel 100, thereby adjusting a flow rate.

FIG. 18 is a diagram of an example, in which a plurality of solar thermal systems according to the second exemplary embodiment of the present invention is installed.

As illustrated in FIG. 18, when the plurality of solar cell panels 100 is connected and used, the plurality of solar cell panels 100 is installed so that the inlets thereof are positioned at lower ends thereof and outlets are also positioned at the upper ends thereof. Further, a plurality of valves 117 is installed at the inlet of the solar cell panel 100, thereby adjusting a flow rate.

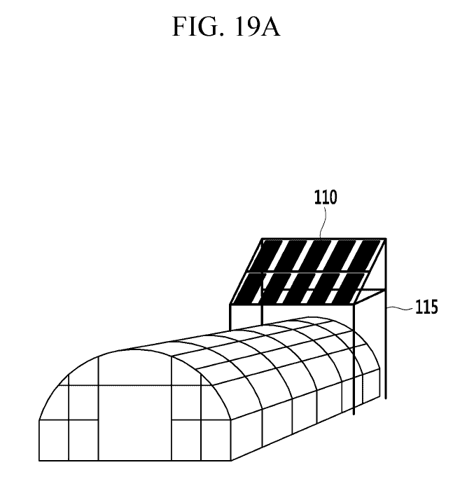

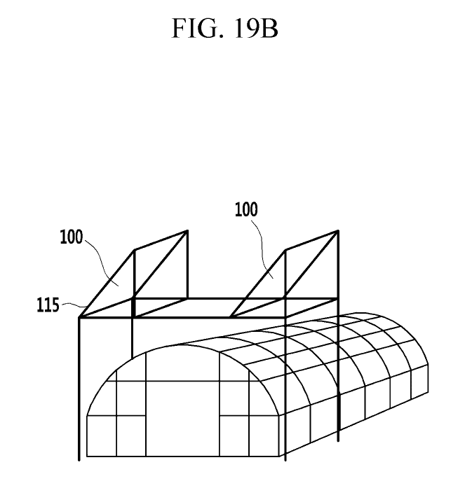

Next, an example, in which the solar thermal system is implemented so that the solar cell panel is installable through FIGS. 15 to 18 and then is installed in an actual environment, will be described with reference to FIG. 19.

FIGS. 19A and 19B are diagrams of an example, in which a solar thermal system according to an exemplary embodiment of the present invention is installed in an actual living environment.

As illustrated in FIGS. 19A and 19B, an installation board is made by using the aluminum quadrangular pipe 115 and is installed so that the solar cell panel 100 is positioned in a south direction. The solar cell panels 100 may also be adjacently installed in parallel as illustrated in FIG. 19A, and the solar cell panels 100 may also be installed to be separated from the adjacent solar cell as illustrated in FIG. 19B.

The installed solar cell panel 100 may also be changed while a position of the solar cell panel 100 is rotated through a turn table (not illustrated).

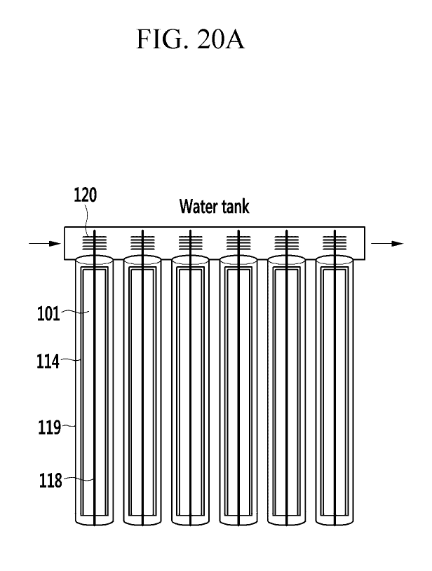

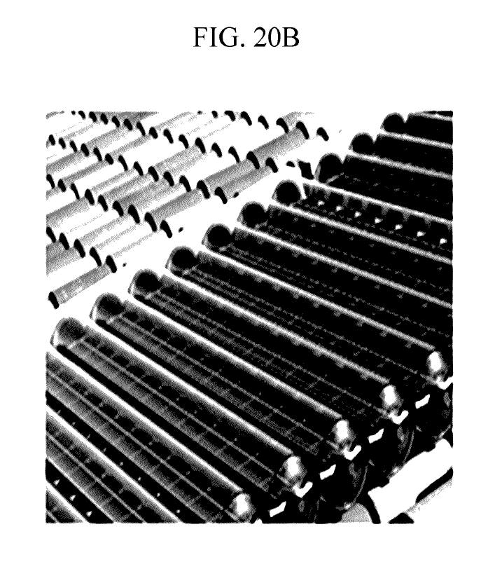

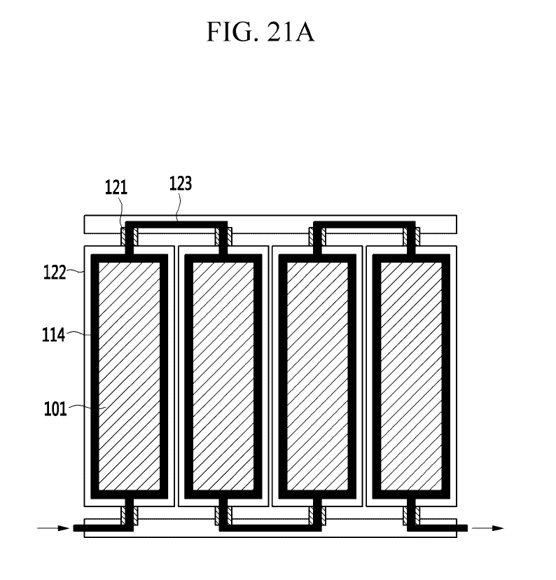

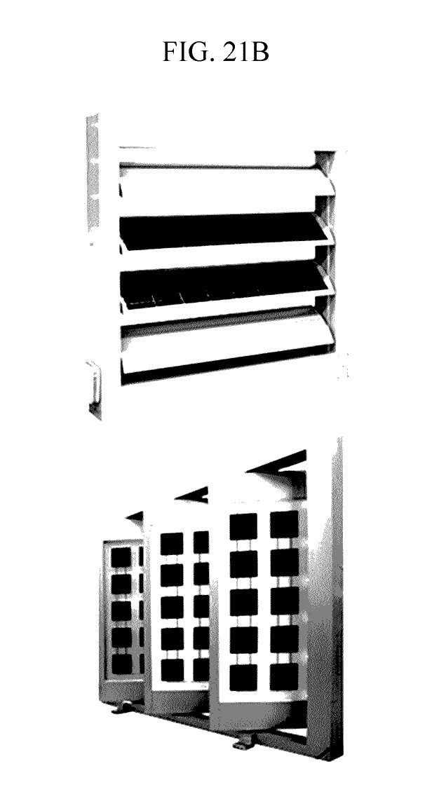

Next, another exemplary embodiment, to which the solar cell is applied, will be described with reference to FIGS. 20 and 21.

FIGS. 20A and 20B are diagrams of an example of the application of the solar cell according to the first exemplary embodiment of the present invention.

As illustrated in FIGS. 20A and 20B, the solar cell 101, the heat absorbing plate 114, and a heat pipe 118 are installed within a vacuum pipe 199 or a glass pipe or a glass pipe. Further, the cooling pin 120 is attached to an end of the heat pipe 118, so that water cooled by the heat pipe 118 generates hot water through heat exchange within a water tank.

The solar cell 101 and the heat absorbing plate 114 may be attached to each other by using a thermal conductive adhesive, a thermal conductive dual-sided tape, or silicon. Further, instead of the heat pipe 118, which is installed at the lower end of the heat absorbing plate 114 and cools water within the water tank by using a cooling agent, a cooling pipe (for example, a copper pipe or an aluminum pipe) may be used, and the heat absorbing plate 114 and the cooling pipe may be bonded by using any one of ultrasonic welding, a thermal conductive adhesive, or silicon.

FIGS. 21A and 21B are diagrams of an example of the application of the solar cell according to the second exemplary embodiment of the present invention.

As illustrated in FIGS. 21A and 21B, a photovoltaic power generation and solar thermal panel is implemented in a blind form and used. The solar thermal panel implemented in the blind form includes the solar cell 101, the heat absorbing plate 114, and a cooling pipe 123 cooling air or water.

The solar cell 101 and the heat absorbing plate 114 may be attached to each other by using any one of a thermal conductive adhesive, a thermal conductive dual-sided tape, and silicon. Further, the heat absorbing plate 114 and the cooling pipe 123 may be attached to each other by using any one of ultrasonic welding, a thermal conductive adhesive, and silicon.

Further, a case 122 is installed on the solar cell 101 to block heat loss to the outside. To this end, the exemplary embodiment of the present invention is described based on an example, in which low iron tempered glass is used as a material of the case 122, but the material of the case 122 is not essentially limited thereto.

Further, it is possible to control a horizontal movement of the case 122 including the solar cell 101 by installing a bearing 121 at the upper end of the case 122, thereby easily tracing sun. Further, it is possible to connect the pipe in serial or in parallel as necessary.

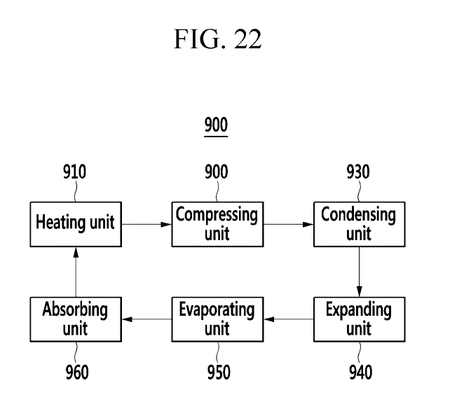

In the above, the various devices and methods providing heating by using the hybrid solar thermal system 10 have been described, but the cooling device 900 connected with the selection switch 800 and the thermal storage tank 500 for providing air conditioning by using the hybrid solar thermal system 10 will be described with reference to FIG. 22. An exemplary embodiment of the present invention is described based on an example, in which an absorption cooling device is used as the cooling device 900.

FIG. 22 is a structure diagram of the cooling device according to the exemplary embodiment of the present invention.

As illustrated in FIG. 22, the cooling device 900 includes a heating unit 910, a compressing unit 920, a condensing unit 930, an expanding unit 940, an evaporating unit 950, and an absorbing unit 960.

The heating unit 910 heats a fluid, in which a coolant and an absorbent are mixed. When the heating unit 910 heats the fluid, the fluid is boiled and gas of the coolant is generated. The exemplary embodiment of the present invention is described based on an example, in which ammonia is used as the coolant and water is used as the absorbent, but the coolant and the absorbent are not essentially limited thereto.

When the gas of the coolant generated by the heating unit 910 flows in, the compressing unit 920 generates high temperature and high pressure compressed gas by compressing the gas. Here, a reference of the high temperature and the high pressure is not set with limitation to any one reference, and the method of compressing the gas of the coolant by the compressing unit 920 is an already known matter, so that the method is not described in detail in the exemplary embodiment of the present invention.

When the high temperature and high pressure compressed gas generated by the compressing unit 920 flows in, the condensing unit 930 condenses the gas and generates a high temperature and high pressure liquid. Here, the liquid corresponds to ammonia that is the coolant.

When the high temperature and high pressure liquid generated by the condensing unit 930 flows in, the expanding unit 940 expands the fluid and generates a low temperature and low pressure liquid.

The evaporating unit 950 evaporates the low temperature and low pressure liquid generated by the expanding unit 940 and generates low temperature and low pressure gas.

A series of processes, in which the absorbing unit 960 absorbs the low temperature and low pressure generated gas by the evaporating unit 950 by using water to generate the coolant, and transmits the generated coolant to the hating unit 910, is repeated, thereby achieving a cooling effect.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A hybrid solar thermal system, comprising:
a solar cell panel configured to absorb solar heat to generate electricity, and transmit the generated electricity in connection with a system of a power supply company;
a thermal storage tank configured to heat an inside fluid by using the electricity drawn from the power supply company to provide heating or cooling;
a boiler configured to provide the fluid heated by the thermal storage tank to provide heating; and
a cooling device configured to allow the fluid heated by the thermal storage tank to flow in a heating unit and provide cooling through heat exchange,
wherein the solar cell panel includes:
a plurality of solar cells configured to absorb solar light and generate electricity;
partitions which are installed at lower ends of the plurality of solar cells, and allow a fluid that is any one of air and water to be circulated;
an insulating material configured to block heat loss to the air; and
a finishing material configured to surround the solar cell.

2. The hybrid solar thermal system of claim 1, wherein:
the partition is formed of any one material among copper, an aluminum metal, stainless and plastic, and is installed in a zigzag form, and
the finishing material is formed of any one material of an aluminum metal, stainless and plastic.

3. The hybrid solar thermal system of claim 2, wherein:
in order to make the solar cell easily absorb heat, the solar cell is provided with an inlet of fluid and an outlet of fluid at a rear surface of the solar cell, an upper end of the solar cell panel, or the upper end and a lower end of the solar cell panel, respectively.

4. The hybrid solar thermal system of claim 1, wherein:
in order to block heat loss to the air, the solar cell panel includes a thermal loss blocking material, which is installed at an upper end of the solar cell.

5. The hybrid solar thermal system of claim 4, further comprising:
connection pipes configured to connect the plurality of solar cell panels.

6. The hybrid solar thermal system of claim 5, wherein:
the solar cell panel further includes:
an installation board configured to support the solar cell; and
an inlet port formed so that a fluid that is any one of air and water passes through a lower side of the solar cell.

7. The hybrid solar thermal system of claim 5, wherein:
the solar cell panel includes
connection pipes configured to connect the plurality of solar cells on a rear surface of the solar cell panel,
a material of the connection pipe is any one of a silicon hose, an ethylene vinyl acetate (EVA) hose, a urethane hose, a copper pipe, an aluminum pipe, a stainless pipe, and plastic pipe, and
the connection pipe is bonded to the rear surface of the solar cell by using any one of a thermal conductive adhesive, an tape, and silicon.

8. The hybrid solar thermal system of claim 7, wherein:
the connection pipe is connected in serial-parallel by using a socket.

9. The hybrid solar thermal system of claim 7, further comprising:
the connection pipe is surrounded by an insulating material realized by one of polyester, glass, wool, glass fiber, isopink, styrofoam, neopor, and then fixed to the solar cell panel.

10. The hybrid solar thermal system of claim 5, further comprising:
a copper pipe, which is installed in parallel on the rear surface of the solar cell panel, includes a fluid inside thereof, and transmits heat, which is generated by the solar cell and moves to the fluid.

11. The hybrid solar thermal system of claim 10, further comprising:
a heat absorbing plate, which is positioned on the rear surface of the solar cell panel, and makes the solar cell panel absorb solar heat,
wherein the heat absorbing plate is plating-processed by any one of anodizing and chromate and used.

12. The hybrid solar thermal system of claim 1, further comprising:
a quadrangular pipe, to which the solar cell panel is fixedly installed.

13. The hybrid solar thermal system of claim 1, further comprising:
a valve, which is installed at an inlet of the solar cell panel, and adjusts a flow rate when a plurality of solar cell panels is connected.

14. The hybrid solar thermal system of claim 1, wherein:
the solar cell and a heat absorbing plate, which absorbs solar heat, are attached by any one of a thermal conductive adhesive, a thermal conductive dual-sided tape, and silicon, and
the hybrid solar thermal system further comprises: a water tank configured to contain water;
a heat pipe, which is installed at a lower end of the heat absorbing plate, and cools water within the water tank by using a coolant; and
a cooling pin, which is installed at one end of the heat pipe, and generates hot water through heat exchange within the water tank.

15. The hybrid solar thermal system of claim 14, further comprising:
a cooping pipe configured to cool air or water;
a case, which is installed on the solar cell, and blocks heat loss to the outside; and
a bearing which is installed at an upper end of the case, and controls a horizontal movement of the case including the solar cell.

16. The hybrid solar thermal system of claim 14, wherein:
the thermal conductive adhesive is an adhesive containing components of silicone modified polymer (20˜30%), fillers (60˜70%), silica (1˜5%), paraffin (1˜5%), carbon black (<0.1), and organic tin compound (0.1˜5%).

17. The hybrid solar thermal system of claim 1, further comprising:
a terminal configured to remotely control a temperature of the thermal storage tank.

18. The hybrid solar thermal system of claim 1, wherein:
the solar cell panels are laid on an installation board implemented by using a quadrangular pipe and are installed in parallel while being adjacent to each other in a south direction, or the plurality of solar cell panel is installed while being spaced apart from the adjacent solar cell panels by a predetermined distance.

19. The hybrid solar thermal system of claim 1, wherein:
the cooling device includes:
a heating unit, in which the fluid heated by the thermal storage tank heats a fluid, in which a coolant and the absorbent are mixed, through heat exchange, and generates a gasified coolant;
a compressing unit configured to compress the gasified coolant generated by the heating unit and generate high pressure and high temperature compressed gas;
a condensing unit configured to condense the high pressure and high temperature compressed gas generated by the compressing unit and generate a high pressure and high temperature liquid;
an expanding unit configured to expand, when the high pressure and high temperature liquid generated by the condensing unit flows in, the high pressure and high temperature liquid and generate a low pressure and low temperature liquid;
an evaporating unit configured to evaporate the low pressure and low temperature liquid generated by the expanding unit and generate low pressure and low temperature gas; and
an absorbing unit configured to make the low pressure and low temperature gas generated by the evaporating unit be absorbed in an absorbent and generate a coolant, and transmit the generated coolant to the heating unit.

20. The hybrid solar thermal system of claim 19, further comprising:
a pump configured to use heat absorbed by a solar heat absorbing device installed on a rear surface of the solar cell as a heat source, and circulate fluid when a difference between a temperature of the solar heat absorbing device and a temperature of the thermal storage tank is equal to or larger than a predetermined temperature; and
a selection switch configured to provide a heated fluid to a heating pump or make a heated fluid flow into a heating unit of the cooling device according to a selection of heating or cooling input from the outside.
